(19) United States
(12) Patent Application Publication
(10) Pub. No.: US 2025/0165803 A1
(43) Pub. Date: May 22, 2025

(54) Federated Artificial Intelligence System For Request Processing Using A Model Chain

(71) Applicant: Zoom Video Communications, Inc., San Jose, CA (US)

(72) Inventors: Xuedong Huang, Yarrow Point, WA (US); Chenguang Zhu, Issaquah, WA (US)

(21) Appl. No.: 18/515,354

(22) Filed: Nov. 21, 2023

(51) Int. Cl. G06N 3/098

(52) U.S. Cl. CPC G06N 3/098

(57) ABSTRACT

A federated artificial intelligence system executes machine learning models of a model chain in order of increasing computational complexity to determine a lowest computational complexity model to use to serve a quality response to a user request. A first machine learning model of the model chain performs an inference operation to produce first output based on the user request. A scoring machine learning model determines that the first output fails to meet a threshold. Based on such determination, a second machine learning model of the model chain performs a second inference operation to produce second output based on the user request, in which the second machine learning model has a higher computational complexity than the first machine learning model. The scoring machine learning model determines that the second output meets the threshold, and, based on such determination, the second output is transmitted in response to the user request.

### FIELD

This disclosure generally relates to a federated artificial intelligence (AI) system, and, more specifically, to a federated AI system that orchestrates the performance of inference operations using machine learning models of a model chain to minimize the computational complexity involved in determining output to present to software service users.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a federated AI system for processing user requests associated with software services of a software platform.

FIG. 5 is a block diagram of example functionality of federated AI system software.

FIG. 6 is a block diagram of an example architecture of machine learning models used with a federated AI system.

FIG. 7 is a block diagram of an example of deliberation between executions of machine learning models of a model chain with a federated AI system.

FIG. 8 is a block diagram of an example of machine learning model and related tuning functionality of a federated AI system.

FIG. 9 is a flowchart of an example of a technique for determining and serving a response to a user request using a federated AI system.

### DETAILED DESCRIPTION

Enterprise entities rely upon several modes of communication to support their operations, including telephone, email, internal messaging, and the like. These separate modes of communication have historically been implemented by service providers whose services are not integrated with one another. The disconnect between these services, in at least some cases, requires information to be manually passed by users from one service to the next. Furthermore, some services, such as telephony services, are traditionally delivered via on-premises solutions, meaning that remote workers and those who are generally increasingly mobile may be unable to rely upon them. One solution is by way of a unified communications as a service (UCaaS) platform, which includes several software services corresponding to multiple communications modalities integrated over a network, such as the Internet, to deliver a complete communication experience regardless of physical location. The software services of a UCaaS platform may thus enable synchronous and asynchronous communications between users. In some cases, the software services of a UCaaS platform may implement other functionality as well, for example, for using digital whiteboards, making workspace reservations, or the like.

A software platform, such as a UCaaS platform, may provide machine learning functionality for use with the software services thereof. Use of the machine learning functionality may enhance the user experience by automating processes, answering prompted questions with minimal or no disruption to an active communication session, or introducing capabilities previously unavailable to software service users. Such machine learning functionality is implemented using one or more machine learning models, which may be trained to process specific types of input and produce specific types of output. For example, machine learning functionality enabled for use during a video conference may be implemented using a large language model (LLM) trained to obtain user requests as natural language prompts and to produce output responsive to the user requests in a same language as that which the prompts are obtained. In one non-limiting example, a video conference participant who joins the video conference after it began may submit a user request to a LLM to ask for a summary of the discussion that occurred during the video conference before the participant joined. The LLM may evaluate a real-time transcription of the video conference (e.g., produced using automated speech recognition or a like tool) to present output concisely summarizing that discussion.

Machine learning models may be implemented for use in a variety of use cases (e.g., language processing, image feature extraction, cyberthreat detection, or recommendation production), using a variety of approaches (e.g., supervised learning, unsupervised learning, or reinforcement learning), and in a variety of structures (e.g., a neural network, decision tree, linear regression, vector machine, Bayesian network, genetic algorithm, or deep learning system). Thus, different machine learning models may process a given user request in different ways involving varying levels of computational complexity, including temporal complexities (i.e., the latency required to produce and serve a response to the user request) and spatial complexities (i.e., the amount of compute resources such as processor and memory required to produce and serve the response). For example, a LLM, which generally operates to analyze text data and predict related text, may be typically understood to be less computationally complex than a deep learning system, which generally operates by processing data across multiple layers each with multiple nodes trained for particular purposes.

The tradeoff to increased computational complexity is often a like increase in the quality of the produced output. For example, a LLM may be less computationally complex than a deep learning system, but the output produced by the LLM may not be as accurate and/or complete as the output produced by the deep learning system for a same user request. Despite this, while it may occasionally be desirable to accept a higher computational complexity to ensure that the resulting output of a user request is of a sufficiently high quality, many user requests are capable of being successfully processed using relatively low-complexity machine learning models. Referring to the above video conference example, the user request submitted as a natural language prompt for a summary of the previous video conference discussion may be easily handled by a LLM; however, a later user request submitted during the video conference that asks for the topics discussed during the video conference to be classified in some way may be better handled by a neural network or deep learning system.

As such, using a relatively low-complexity machine learning model to address a user request may result in the output being of a compromised quality, while using a relatively high-complexity machine learning model to address a user request may well result in the unnecessary consumption of valuable system resources. Nevertheless, conventional software services that utilize machine learning functionality, such as those of a UCaaS or other software platform, are unable to correlate user requests to certain complexities of machine learning model. Thus, these conventional software services are unable to preserve system resources while ensuring quality of produced output by directing machine learning user request traffic to machine learning models of appropriate complexities. Furthermore, conventional software services that utilize machine learning functionality generally dedicate certain types of machine learning models to certain types of user requests. In doing so, these conventional software services fail to leverage the potential increase in quality of produced output that could otherwise result from providing the output of one type of machine learning model as part of the input to another type.

Implementations of this disclosure address problems such as these by way of a federated AI system that uses a model chain to process requests. The federated AI system executes one or more machine learning models of a model chain to process a user request, in order to determine a machine learning model of the model chain to use to serve output responsive to the user request. In particular, the federated AI system uses a scoring machine learning model, trained to evaluate the quality of output of machine learning models of the model chain, to determine a lowest computational complexity model of the model chain that produces output meeting a performance threshold. The model chain is a sequence of machine learning models of increasing computational complexity, in which a first machine learning model of the model chain has a lowest computational complexity of the model chain and a last machine learning model of the model chain has a highest computational complexity thereof.

When a user request is received by the federated AI system, the user request is provided as input to the first machine learning model of the model chain. That first machine learning model produces output by performing an inference operation against the user request. The scoring machine learning model compares that output against a threshold to determine whether to serve the output in response to the user request. In particular, the threshold represents a quality measure that, if met by a score produced by the scoring machine learning model for the output, indicates that the first machine learning model was capable of producing a sufficiently high quality output in response to the user request. Thus, where the score for the output of the first machine learning model meets the threshold, the output is transmitted in response to the user request. However, where the score fails to meet the threshold, the federated AI system executes a next machine learning model of the model chain, having a higher computational complexity than the first machine learning model thereof, to perform an inference operation based on the user request. The output of that next machine learning model is scored by the scoring machine learning model, and that score is compared against the same or a different threshold to determine whether to transmit it in response to the user request or to execute a next machine learning model of the model chain.

This process repeats until either the score for an output is determined to meet a threshold or a last machine learning model of the model chain is executed. The last machine learning model has a highest computational complexity amongst the machine learning models of the model chain. To ensure that the last machine learning model of the model chain produces a sufficiently high quality output in response to the user request, the last machine learning model is treated as a super processing unit which executes multiple machine learning models in parallel. In some cases, the super processing unit aggregates, averages, or otherwise combines their output to produce a final output to transmit in response to the user request. In other cases, the scoring machine learning model evaluates the individual output of those multiple machine learning models and determines one of them as having produced an output with a highest score, in which that output is transmitted in response to the user request. Accordingly, using the implementations of a federated AI system as disclosed herein, lower complexity user requests and thus a majority of user request traffic can be handled by lower complexity models, thereby reserving system resources for higher complexity models for higher complexity user requests instead.

In some cases, cross-model deliberation may be performed across the model chain by providing the output of one or more previous machine learning models of the model chain as an input to a next machine learning model of the model chain. For example, a second machine learning model of the model chain may perform an inference operation using input including the user request and information representative of output produced based on an inference operation performed against the user request by a first machine learning model of the model chain. Similarly, a third machine learning model of the model chain may perform an inference operation using input including the user request, information representative of output produced based on an inference operation performed against the user request by the second machine learning model of the model chain, and information representative of output produced based on an inference operation performed against the user request by the first machine learning model of the model chain. Thus, each successive machine learning model of the model chain uses the output of the previously executed machine learning models thereof to guide its inferencing.

In some such cases, information associated with output produced by the scoring machine learning model in evaluating the output of previous machine learning models may also be provided as input for this deliberation. For example, the input provided to the second machine learning model may include the user request, the information representative of the output produced by the first machine learning model, and information representative of the score determined for the output produced by the first machine learning model. The information representative of the score may, for example, be, include, or otherwise refer to a score itself and/or a rationale explaining how the score was determined. These approaches for deliberating between machine learning model executions result in higher quality output being produced and transmitted in response to the user request, based on the previous outputs being used as guides for the later inferencing.

Other approaches are also described for use with the federated AI system, for example: approaches for fine tuning machine learning models and related information (e.g., thresholds), such as those that use human-in-the-loop (HITL) labeling data to improve the quality of output produced by one or more machine learning models of the model chain; approaches that dynamically select next machine learning models to include in the model chain based on the user request and/or a user device at which the user request is initiated; approaches for incrementally outputting information to reduce the perceived latency of user request processing; and so on.

In some examples of this disclosure, implementations may include or otherwise use one or more artificial intelligence or machine learning (collectively, AI/ML) systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

To enhance privacy and safety, as well as provide other benefits, the AI/ML processing system may be prevented from using a user's or organization's personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

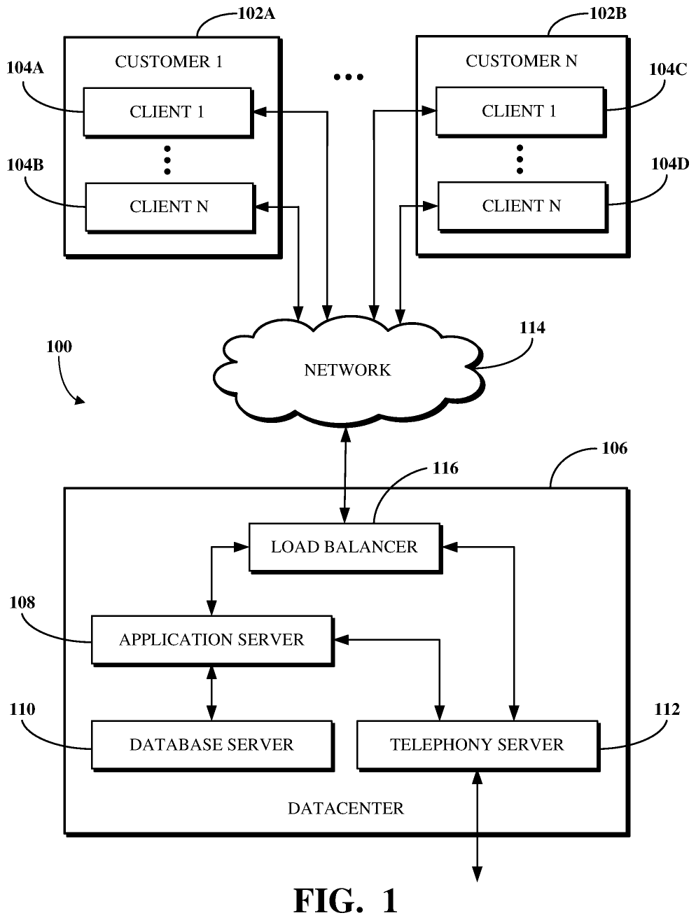

To describe some implementations in greater detail, reference is first made to examples of hardware and software structures used to implement a federated AI system. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

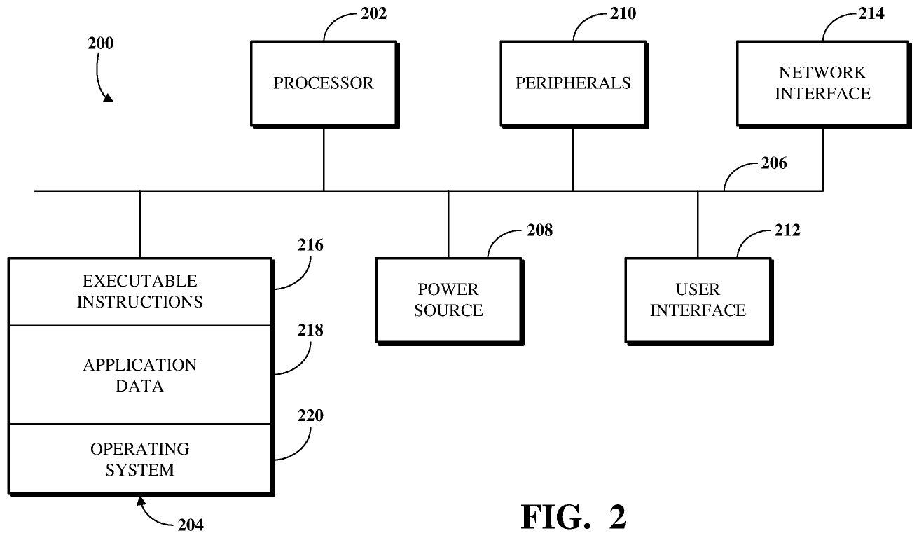

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

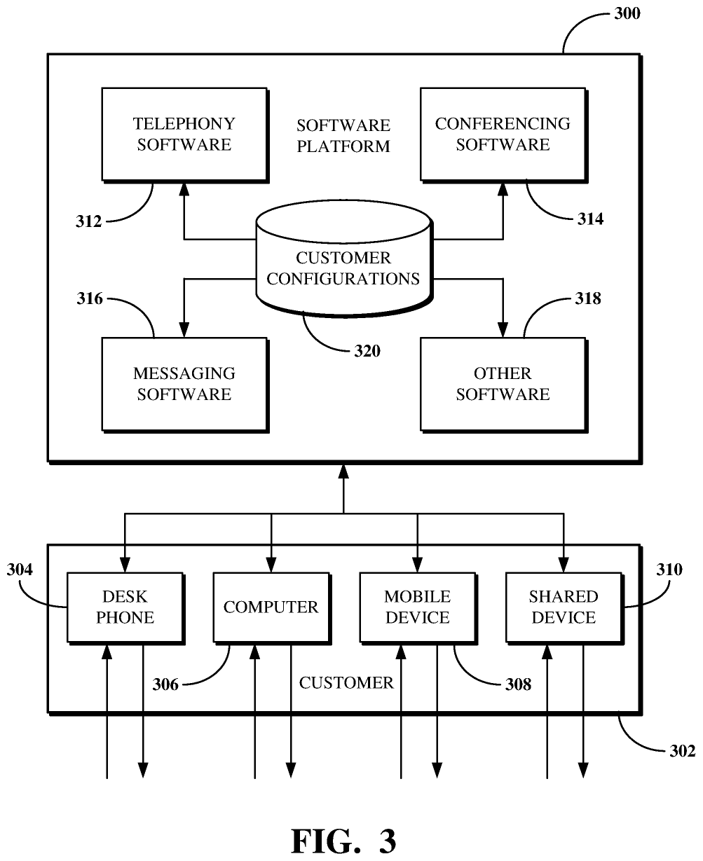

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include federated AI system software for processing user requests obtained via a software service of the software platform 300 (e.g., via one of the software 312 through 316) using varying computational complexity machine learning models of a model chain.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

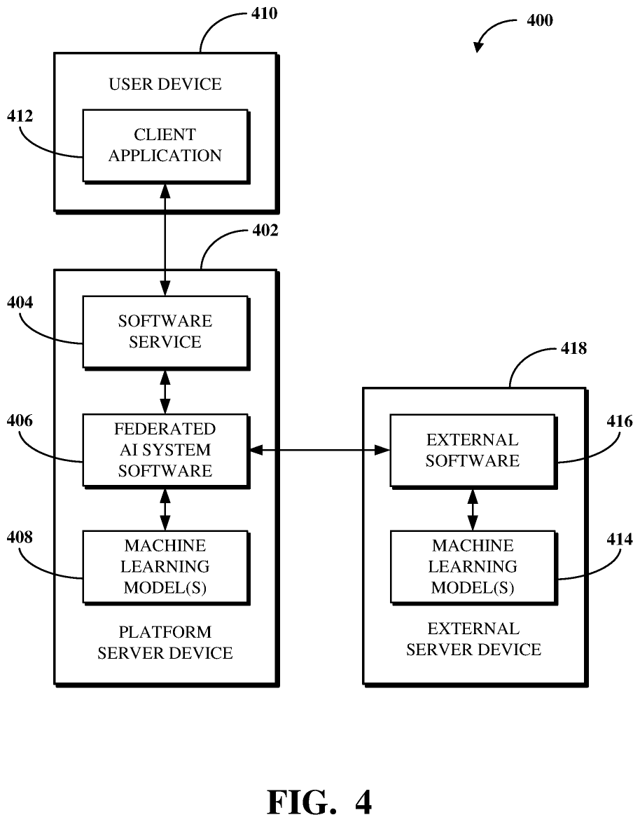

FIG. 4 is a block diagram of an example of a federated AI system 400 for processing user requests associated with software services of a software platform, such as the software platform 300 shown in FIG. 3. The federated AI system 400 includes a platform server device 402 that implements a software service 404, federated AI system software 406, and one or more machine learning models 408. For example, the platform server device 402 may include one or more application servers and/or database servers, such as the application server 108 and the database server 110 shown in FIG. 1, used to implement the software service 404, the federated AI system software 406, and the one or more machine learning models 408. In some cases, the platform server device 402 may be or otherwise include multiple servers. In such a case, the software service 404, the federated AI system software 406, and the one or more machine learning models 408 may be implemented across the multiple servers in one or more ways.

The software service 404 is, includes, or otherwise refers to the components used to run (e.g., execute or interpret) application-level software. For example, the software service 404 may facilitate synchronous or asynchronous communications, such as via one of the software services 312 through 316 shown in FIG. 3. In another example, the software service 404 may facilitate functionality directly related, indirectly related, or unrelated to synchronous or asynchronous communications, such as appointment scheduling, event hosting, knowledgebase compilation, digital whiteboarding, workspace reservation, and the like. The software service 404 may thus be one of many software services of the software platform, in which some or all of those other software services may also be implemented by the platform server device 402 or by one or more other server devices associated with the software platform.

The software service 404 is accessed by a user device 410, which is a personal or shared computing device configured to run a client application 412 associated with the software service 404. For example, the user device 410 may be one of the clients 304 through 310 shown in FIG. 3. The client application 412 may be a software application installed on the user device 410 and used to access the various software services of the software platform via one or more client-side graphical user interfaces (GUIs). Alternatively, the client application 412 may be a web-based application instantiated based on requests processed in connection with a web browser running at the user device 410. In some implementations, the client application 412 may be omitted, in which case the user device 410 may instead access the software service 404 using other web browser-based approaches or a different software application.

In one non-limiting example, the software service 404 may correspond to conferencing software (e.g., the conferencing software 314 shown in FIG. 3) for facilitating video conferences between users of user devices including the user device 410. The user of the user device 410 connects to the video conference via the client application 412, which interfaces with the software service 404 to cause the user device 410 to join the video conference and thus enable synchronous communications over video and/or audio with the users of the other user devices. For example, the client application 412 may encode a video stream captured at the user device 410 and transmit the encoded video stream for rendering at the other user devices, and it may similarly receive encoded video streams originating at those other user devices and decode same to render the video of the other user device users at the user device 410. The user of the user device 410 may similarly use the client application 412 to access related functionality of the video conference, for example, chat tools for interacting with one or more participants via text, AI tools for summarizing video conference content, and the like.

The software service 404 may receive user requests initiated at the user device 410. The user requests are related to functionality of the software service 404 and correspond to tasks to be actioned by or otherwise on behalf of the software service 404, to generate and transmit responses to the user requests. Non-limiting examples of user requests include requests to summarize video conference content, requests to schedule an appointment or reserve a workspace, requests to classify digital whiteboards by content or creator, and the like. A user request may be initiated at the user device 410 in one or more ways, including, for example, by the user device 410 obtaining input from a user thereof, such as in response to a prompt.

The federated AI system software 406 obtains such a user request from the software service 404 and causes the one or more machine learning models 408 to process the user request to produce output responsive to the user request. The federated AI system software 406 then transmits the output to the software service 404 for the software service 404 to present to the user device 410. In particular, the federated AI system software 406 orchestrates the execution of the one or more machine learning models as part of a model chain by causing the one or more machine learning models 408, in sequence, to perform an inference operation to produce output based on the user request. The federated AI system software 406 obtains the output from a machine learning model 408 of the model chain and evaluates that output using a scoring machine learning model to determine whether a score for the output meets a threshold. Where the score meets the threshold, the output from the machine learning model 408 is transmitted in response to the user request, such as by the federated AI system software 406 passing the output to the software service 404 for the software service 404 to serve to the user device 410. Where the score fails to meet the threshold, the federated AI system software 406 causes an execution of a next machine learning model 408 of the model chain, obtains the output from that next machine learning model 408, and evaluates that output using the scoring machine learning model to perform a threshold comparison as described above. The process repeats until either the score for an output meets its corresponding threshold or output is obtained from a last machine learning model 408 of the model chain.

In some cases, the federated AI system software 406 may cause an execution of one or more machine learning models 414 external to the software platform associated with the platform server device 402. For example, the one or more machine learning models 414 may be machine learning models under the control, operation, or other use by an entity separate from the software platform associated with the platform server device 402. The federated AI system software 406 may cause an execution of a machine learning model 414 may transmitting a request, for example, via an application programming interface (API) call, to external software 416, which is frontend and/or backend software associated with the implementation of the machine learning model 414 and which is run at an external server device 418. For example, the federated AI system software 406 may transmit a request to execute a machine learning model 414 to the external software 416, in which the request includes input for the machine learning model 414 to use (e.g., the user request). The external software 416 then executes, or otherwise causes an execution of, the machine learning model 414 based on the request to cause the machine learning model 414 to perform an inference operation against that input. The external software 416 obtains the output produced based on the inference operation performed by the machine learning model 414 and passes that output to the federated AI system software 406. The federated AI system software 406 then evaluates the output using the scoring machine learning model, as described above. Thus, in some cases, a model chain used with the federated AI system 400 may include one or more machine learning models 408 internal to a software platform and one or more machine learning models 414 external to the software platform.

In some implementations, the federated AI system software 406 may cause an execution of one or more machine learning models at the user device 410. For example, the client application 412 may include or otherwise obtain (e.g., download from a source external to the user device 410) executable instructions for implementing a machine learning model at the user device 410. In some such implementations, the one or more machine learning models implemented at the user device 410 may be the first machine learning models of the model chain. Thus, server-side user request traffic may in such cases be avoided or at least limited based on the processing of user requests being handled at the client-side.

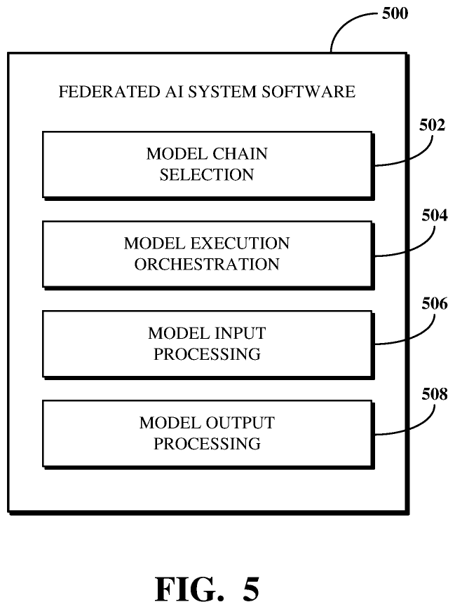

To further describe functionality of the federated AI system 400, reference is made to FIG. 5, which is a block diagram of example functionality of federated AI system software 500. The federated AI system software 500 may, for example, be the federated AI system software 406 shown in FIG. 4. The federated AI system software 500 includes tools, such as programs, subprograms, functions, routines, subroutines, operations, and/or the like, for processing user requests obtained via a software service using varying computational complexity machine learning models of a model chain. As shown, the federated AI system software 500 includes a model chain selection tool 502, a model execution orchestration tool 504, a model input processing tool 506, and a model output processing tool 508.

The model chain selection tool 502 selects a model chain to use for a user request. The model chain includes multiple (i.e., two or more) machine learning models which are trained to process user requests of the type corresponding to the user request (e.g., summary generation, text-based chat, or image processing). In one non-limiting example, the machine learning models of the model chain may be LLMs. The machine learning models are of varying computational complexity and arranged in the model chain according to their relative computational complexities. For example, the computational complexity of a machine learning model may be determined (e.g., prior to the selection of the machine learning model for use in the model chain or at the time of such selection) based on a measure of time and computing resources required to perform an inference operation against a test input sample.

Default model chains may be determined for use with certain types of user requests. For example, a default model chain for handling user requests for text content summaries or predictive text prompts (e.g., as may be submitted to an AI chatbot) may include specific LLMs arranged in order of their relative computational complexity. The model chain selection tool 502 may select the default model chain corresponding to the type of the user request. In some cases, there may be default model chains defined for use with specific software service functionality. For example, a first default model chain may be defined for use with an AI summary generator tool of conferencing software, a second default model chain may be defined for use with an object recognition tool of the conferencing software, and a third default model chain may be defined for use with a chatbot tool of the conferencing software. In such a case, the model chain selection tool 502 may select the default model chain corresponding to the software service functionality in connection with which the user request is initiated.

Alternatively, the model chain selection tool 502 may dynamically select a model chain for the user request based on one or more factors, including, for example, the user request and/or the user device at which the user request is initiated (e.g., the user device 410 shown in FIG. 4). For example, in response to the user request, the model chain selection tool 502 may determine multiple machine learning models to select to include in a model chain dynamically prepared for the user request. In such a case, the model chain selection tool 502 may access a record indicative of data such as computational complexities, trained data types, and more for machine learning models available to the federated AI system. In some cases, the model chain selection tool 502 may dynamically select individual machine learning models to include within the model chain on the fly. For example, a first machine learning model may be universally defined for all user requests or user requests of a given type. Following the processing of output produced by that first machine learning model, as described below with respect to the model output processing tool 508, a next machine learning model to include in the model chain may be dynamically select based on, for example, that output and/or a score determined for that output.

As a further alternative, the model chain selection tool 502 may select a model chain by evaluating candidate model chains. For example, the model chain selection tool 502 may identify multiple candidate model chains to evaluate according to the user request, such as described above. The model chain selection tool 502 may then evaluate each candidate model chain using the user request or a sample request, such as by using a scoring machine learning model as disclosed herein, to determine the candidate model chain that resulted in a highest score for machine learning model output or in a score of such output that meets a threshold in a shortest amount of time. That candidate model chain may then be selected as the model chain to use for processing the user request.

The model execution orchestration tool 504 orchestrates the sequential execution of the machine learning models of the model chain selected by the model chain selection tool 502. In particular, the model execution orchestration tool 504 causes an execution of a first machine learning model of the model chain, resulting in the first machine learning model performing an inference operation against the user request. Based on an output produced according to that inference operation failing to meet a threshold, as described below with respect to the model output processing tool 508, the model execution orchestration tool 504 causes an execution of a next machine learning model of the model chain, according to input provided as described below with respect to the model input processing tool 506. The model execution orchestration tool 504 proceeds to cause an execution of each next machine learning model of the model chain until an output of a machine learning model meets a threshold or a last machine learning model of the model chain is executed, as disclosed herein. The model execution orchestration tool 504 maintains an understanding of a currently executing or otherwise most recently executed machine learning model of the model chain, in order to understand a next machine learning model thereof to execute, as applicable.

To cause the execution of a given machine learning model of the model chain, the model execution orchestration tool 504 transmits a request (e.g., via API call) to software configured to utilize the machine learning model. In some cases, the model execution orchestration tool 504 may directly execute a machine learning model without the request therefor being processed by an intermediary software component. For example, a machine learning model implemented at the user device at which the user request is initiated may be executed based on a command transmitted from the model execution orchestration tool 504 to a client application running at the user device (e.g., the client application 412 shown in FIG. 4). In another example, a machine learning model implemented at a server under the control of a software platform that uses the federated AI system software 500 (e.g., the platform server device 402 shown in FIG. 4) may be executed based on a command transmitted from the model execution orchestration tool 504 to the machine learning model or to backend software used to operate the machine learning model. In yet another example, a machine learning model implemented at a server external to the software platform (e.g., the external server device 418 shown in FIG. 4) may be executed based on an API call to external software used to operate the machine learning model (e.g., the external software 416 shown in FIG. 4).

The model input processing tool 506 determines input to provide to a machine learning model to be executed by the model execution orchestration tool 504 and provides the input accordingly. The input generally refers to the data and/or other elements against which the machine learning model will perform the subject inference operation. The input provided to each machine learning model of the model chain by the model input processing tool 506 will at least include the user request. However, in some cases, the input may additionally include other contents, for example, information representative of the output produced by one or more previous machine learning models of the model chain, information representative of scores determined based on such output, and/or feature-specific content corresponding to the user request (e.g., a real-time or historic video conference transcription usable to determine information related to a video conference).

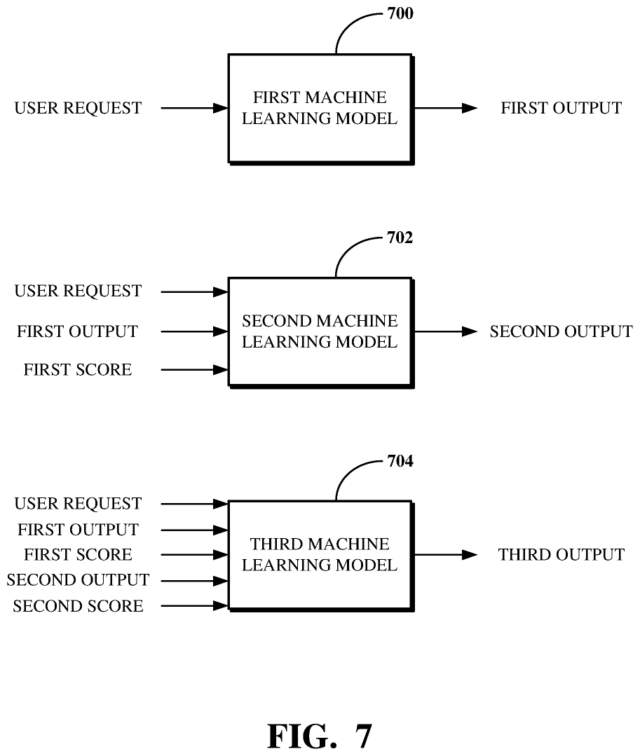

In particular, and as will further be described with respect to FIG. 7, the model input processing tool 506 can enable cross-model deliberation within the model chain to cause a second or later machine learning model in the model chain to obtain, as part of the input, information indicative of the performance of and by one or more previously executed machine learning models of the model chain. For example, implementing this deliberation can include providing the output of the first machine learning model of the model chain as part of the input for the second machine learning model of the model chain, providing the output of the first and second machine learning models of the model chain as part of the input for the third machine learning model of the model chain, and so on. In some cases, descriptive information representative of some or all of such output may be provided in place of the output itself. That is, new input may be generated based on the output to provide guidance for the inference operation performance by the next machine learning model of the model chain. For example, where the machine learning models of the model chain are LLMs, the new input provided via the deliberation may include human- and/or machine-generated text describing the inference operation performance by one or more previous machine learning models of the model chain and/or the output produced based on such performance.

Alternatively, or additionally, part of the input provided to the machine learning models of the model chain via this deliberation may include scores determined for output produced by the one or more machine learning models preceding a given machine learning model and/or descriptive information representative of the rationales underlying the determination of such scores. In particular, and as will be described below with respect to the model output processing tool 508, the output produced by a machine learning model of the model chain is evaluated using a scoring machine learning model to determine a score for that output, in which the score represents a measure of the performance by the machine learning model in producing the output. Score information may thus be indicative of a performance measure of the previous one or more machine learning models, for example, to indicate to a current machine learning model how close or far those one or more machine learning models were from meeting a threshold against which the score information was compared. The rationale information may relatedly describe how and why the output produced by those previous one or more machine learning models failed to meet the threshold. In some cases, the rationale information may be or otherwise include observational input manually entered by a user.

The model output processing tool 508 processes output produced based on the inference operations performed by the machine learning models of the model chain to determine whether to transmit such output in response to the user request. As described above, the model output processing tool 508 uses a scoring machine learning model configured (i.e., trained) to measure the quality of output produced by the machine learning models of the model chain. The scoring machine learning model is a discriminative model trained to determine scores for output produced via the inference operations performed by the machine learning models, using the input provided by the model input processing tool 506, and to evaluate those scores against one or more thresholds to measure performance of the machine learning models. For example, the scoring machine learning model may be trained as a regression model using a training data set including human- and/or machine-labeled data. The scores determined using the scoring machine learning model may, for example, be expressed as s=Z(x, y)∈[0, 1], in which s is the score, Z is the scoring machine learning model, x is the input provided to the subject machine learning model under evaluation, and y is the output produced by that machine learning model.

The score determined for the output of a machine learning model is used to determine whether to serve that output to the user device in response to the user request. In particular, the model output processing tool 508 compares the scores determined for the output of the machine learning models against thresholds representative of performance measurements for the machine learning models to determine whether those scores meet those thresholds. Specifically, each score is compared against a single threshold. In some cases, the same threshold is used for multiple or all machine learning models of the model chain. In other cases, different thresholds are used for each machine learning model of the model chain. The thresholds may, for example, be defined based on empirical offline training to indicate values according to some measurable unit at which the quality of the respective output is sufficient to address a subject user request. Thus, the specific value to which a given threshold corresponds may be recognized by the model output processing tool 508 according to a designation to use that threshold for all machine learning models or instead based on the machine learning model which produced the output for which a given score is being evaluated. Moreover, a score may be considered to meet a threshold where the value of the score is greater than or equal to the threshold. Alternatively, a score may be considered to meet a threshold where the value of the score is greater than the threshold. As a further alternative, a score may be considered to meet a threshold where the value of the score is within an acceptable range (e.g., a standard deviation or margin of error) of the threshold.

Although the tools 502 through 508 are shown as separate tools, in some implementations, two or more of the tools 502 through 508 may be combined into a single tool. Although the tools 502 through 508 are shown as functionality of the federated AI system software 500 as a single piece of software, in some implementations, some or all of the tools 502 through 508 may exist outside of the federated AI system software 500, or the federated AI system software 500 may be implemented as multiple software aspects running at the same or different computing devices.

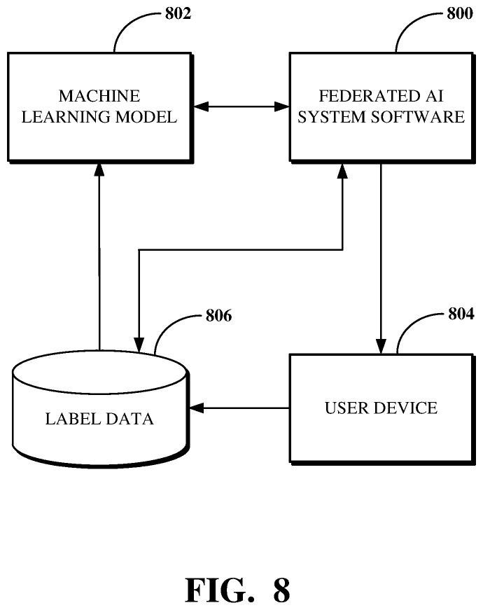

In some implementations, the federated AI system software 500 may include one or more other tools in addition to the tools 502 through 508. For example, the federated AI system software 500 may include a fine-tuning tool for updating aspects of the federated AI system that uses the federated AI system software 500. The fine-tuning tool may perform tuning against one or more machine learning models used by the federated AI system software 500, one or more thresholds used by the federated AI system software 500, and/or other software or informational aspects used by the federated AI system software 500. Implementations and examples of such tuning are described below with respect to FIG. 8.

In another example, the federated AI system software 500 may include an output streaming tool for reducing the perceived latency of output production using the model chain. In particular, the federated AI system software 500 may transmit some or all of the output produced by one or more machine learning models of the model chain for output at the user device at which the user request initiated even before the model output processing tool 508 identifies a final output to serve in response to the user request. For example, some or all of first output produced by a first machine learning model of the model chain can be presented as output at the user device while a second and/or later machine learning model of the model chain performs an inference operation against the input provided thereto. Similarly, some or all of second output produced by a second machine learning model of the model chain can be presented as output at the user device (e.g., alongside the first output described above or to replace the display of the first output at the user device) while a third and/or later machine learning model of the model chain performs an inference operation against the input provided thereto. In this way, there may constantly, or at least at one or more times during the processing of the user request using the model chain, be some information presented at the user device in response to the user request. This may maintain user engagement, which can be increased as updates with new portions of output are presented as described herein. As a result, the latency introduced by the processing of the user request by multiple machine learning models of the model chain may be perceived by the user of the user device as being less than it actually is.

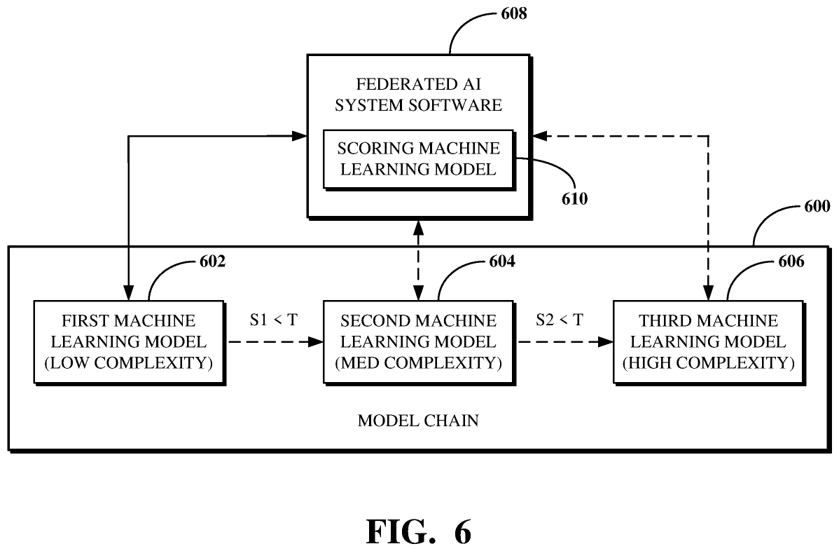

To further describe a federated AI system according to the implementations of this disclosure, reference is next made to FIGS. 6 through 8, which describe examples of functionality of the tools 502 through 508. FIG. 6 is a block diagram of an example architecture of machine learning models used with a federated AI system, such as the federated AI system 400 shown in FIG. 4. In particular, a model chain 600 is shown by example as including a first machine learning model 602, a second machine learning model 604, and a third machine learning model 606, in which the first machine learning model 602 has a lowest computational complexity of the model chain 600 and the third machine learning model 606 has a highest computational complexity of the model chain 600. For example, the model chain may be determined using the model chain selection tool 502 shown in FIG. 5. While three machine learning models 602 through 606 are shown in FIG. 6 by example, in some implementations, the model chain 600 may instead include other numbers of machine learning models.

The locations of the machine learning models 602 through 606 may differ based on the specific implementation. For example, the first machine learning model 602 and the second machine learning model 604 may be machine learning models internal to a software platform, such as the machine learning models 408 shown in FIG. 4, while the third machine learning model 606 may be a machine learning model external to the software platform, such as the machine learning model 414 shown in FIG. 4. In another example, the first machine learning model 602 may be a machine learning model internal to a software platform while the second machine learning model 604 and the third machine learning model 606 may be machine learning models external to the software platform. In yet another example, all three of the machine learning models 602 through 606 may be machine learning models internal or external to a software platform. Thus, the illustrated grouping of the machine learning models 602 through 606 as shown in FIG. 6 does not import limitations on the locations of those models.

Each of the machine learning models 602 through 606 interfaces, whether directly or indirectly (e.g., via intermediary software) with federated AI system software 608, which may, for example, be the federated AI system software 500 shown in FIG. 5. In particular, the federated AI system software 608 provides input to and obtains output from each of the machine learning models 602 through 606 that are executed in connection with a user request. The federated AI system software 608 includes or otherwise uses a scoring machine learning model 610 to evaluate the output obtained from the ones of the machine learning models 602 through 606. In particular, the federated AI system software 608 controls the sequential execution of the machine learning models 602 through 606 in the order in which are arranged within the model chain 600 by providing input to one machine learning model, obtaining output from that machine learning model, and determining whether to serve that output in response to the user request or to instead execute a next machine learning model based on a score determined for that output using the scoring machine learning model 610.

To illustrate, the federated AI system software 608 determines the model chain 600 and then causes the execution of the first machine learning model 602. The first machine learning model 602 executes to perform an inference operation against first input provided by the federated AI system software 608, which first input includes the user request for which the federated AI system software 608 determined the model chain 600. The first machine learning model 602 performs the inference operation against the first input to produce first output, which is then processed by the scoring machine learning model to determine a first score, illustrated as S1. The federated AI system software 608 determines (i.e., via a comparison) whether the first score meets a threshold, illustrated as T. In the event the first score meets the threshold, the first output is transmitted by the federated AI system software 608 in response to the user request, such as for display at the user device at which the user request was initiated.

In the event the first score fails to meet the threshold, the federated AI system software 608 causes the execution of the second machine learning model 604, as the next machine learning model of the model chain. The second machine learning model 604 executes to perform an inference operation against second input provided by the federated AI system software 608, which second input includes the user request and may in some cases additionally include one or more of the first output produced by the first machine learning model 602, information representative of that first output, the first score determined for that first output, or information representative of that first score. The second machine learning model performs the inference operation against the second input to produce second output, which is then processed by the scoring machine learning model to determine a second score, illustrated as S2. The federated AI system software 608 determines (i.e., via a comparison) whether the second score meets a threshold, which may be the same threshold T used in the evaluation of the first score or which may be a different threshold. In the event the second score meets the threshold, the second output is transmitted by the federated AI system software 608 in response to the user request, such as for display at the user device at which the user request was initiated.

In the event the second score fails to meet the threshold, the federated AI system software 608 causes the execution of the third machine learning model 606, which is both the next and last machine learning model of the model chain. The third machine learning model 606, being the last machine learning model of the model chain, executes multiple machine learning models to each individually perform against third input provided by the federated AI system software 608, which third input includes the user request and may in some cases additionally include one or more of the first output produced by the first machine learning model 602, information representative of that first output, the first score determined for that first output, information representative of that first score, the second output produced by the second machine learning model 602, information representative of that second output, the second score determined for that second output, or information representative of that second score. The machine learning models executed by the third machine learning model each individually performs an inference operation against the third input to produce third output. The third output produced by each of the machine learning models is then processed to determine a final output to serve in response to the user request. For example, the third outputs produced by the individual machine learning models may be evaluated against one another to determine, as the final output, the one of the third outputs having a highest score (e.g., based on the scoring machine learning model 610 processing the third outputs). In another example, the third outputs may be aggregated, averaged, or otherwise combined to produce the final output. The federated AI system software 608 transmits the final output in response to the user request, thereby concluding the processing of the user request using the model chain 600.

FIG. 7 is a block diagram of an example of deliberation between executions of machine learning models of a model chain with a federated AI system, such as the federated AI system 400 shown in FIG. 4. The deliberation, as disclosed herein, refers to the use of output of one or more previous machine learning models of a model chain, directly or indirectly, as input for a later machine learning model of the model chain. As shown, a model chain may include a first machine learning model 700, a second machine learning model 702, and a third machine learning model 704, which may, for example, be the machine learning models 602 through 606 shown in FIG. 6. While three machine learning models 700 through 704 are shown by example, in some implementations, other numbers of machine learning models may be involved in deliberation as disclosed herein.

Each of the machine learning models 700 through 704 uses input, shown on its left, and producing output, on its right. The output produced by each of the machine learning models 700 through 704, while different in content, will be the same or at least similar in form, based on the machine learning models 700 through 704 being of a same type of machine learning model (e.g., based on them all being LLMs). For example, the first machine learning model 700 produces first output, the second machine learning model 702 produces second output, and the third machine learning model 704 produces third output.

However, the input used by each of the machine learning models 700 through 704 differs due to the deliberation such that the input used by a later machine learning model of the model chain generally includes more items than the input used by an earlier machine learning model of the model chain. For example, the first machine learning model 700 uses input including only the user request. The second machine learning model 702 uses input including that user request as well as information resulting from the execution of the first machine learning model 700, such as the first output and a first score determined for that first output. In some cases, information representative of the first output may be provided in place of the first output itself and/or information representative of the first score may be provided in place of the first score itself. The third machine learning model 704 uses input including the user request as well as information resulting from the executions of the first machine learning model 700 and the second machine learning model 702, such as the first output, the first score, the second output, and a second score determined for that second output. In some cases, information representative of the first and/or second output may be provided in place of the first and/or second output itself and/or information representative of the first and/or second score may be provided in place of the first and/or second score itself.

The deliberation shown and described with respect to FIG. 7 thus generally follows a sequential order in which the input of a later machine learning model is based on the output of a previous machine learning model. Nevertheless, in some implementations, other approaches to deliberation may be performed with the federated AI system. For example, each of the machine learning models 700 through 704 can execute simultaneously during a first pass using input including the user request. The output produced by each of the machine learning models 700 through 704 can then be scored (e.g., using the scoring machine learning model 610 shown in FIG. 6) to determine the machine learning model that produced the highest scoring output (i.e., by comparing the scores determined for those outputs). Via deliberation, that machine learning model can then perform, during a second pass, another inference operation using the user request and the output produced by some or all of the machine learning models 700 through 704 during the first pass. The resulting score may then be determined and compared against the score previously determined for that machine learning model. In some cases, the deliberation may repeat with further passes until the score determined for the output meets a threshold, ceases to increase by a threshold amount (i.e., relative to the previous score for the machine learning model), or ceased to increase at all (i.e., relative to that previous score). Other approaches for deliberation within the federated AI system are also possible.

In some implementations, a self-federation deliberation may be performed by which a same machine learning model produces output based on a first inference operation and thereafter receives input including that same output (or information representative thereof), the user request, and scoring output (or information representative thereof). For example, the first machine learning model 700 and the second machine learning model 702 may be the same machine learning model. In such a case, the machine learning model receives first input including a user request and performs a first inference operation based on that first input to produce first output, which is then scored to produce scoring output. The same machine learning model can then receive second input including the user request, the first output, and the scoring output and performing a second inference operation based on that second input to produce second output.

FIG. 8 is a block diagram of an example of machine learning model and related tuning functionality of a federated AI system, such as the federated AI system 400 shown in FIG. 4. The federated AI system, via federated AI system software 800 (e.g., the federated AI system software 500 shown in FIG. 5) or otherwise, includes functionality for tuning (e.g., training, retraining, balancing, and rebalancing) aspects used by the federated AI system, such as machine learning models of model chains, thresholds used to evaluate scores determined for outputs of those machine learning models, and the like. In particular, such tuning functionality (e.g., implemented as a tool of the federated AI system software 800) may process the output produced by a machine learning model 802 of the model chain to determine a label for the output. In some cases, the label may be automatically determined by the tuning functionality or another aspect of the federated AI system 400 based on a score determined for the output meeting a threshold. That is, the system may automate the generation of a label where the output is demonstrated to be of a sufficient quality (i.e., according to the threshold comparison).

However, where the score for the output fails to meet the threshold, the output may be presented to a user device 804 to enable a user thereof to provide input representing a manually generated label. The user device 804 is a computing device configured for use by a human user. In some cases, the user device 804 may be a user device at which a user request that resulted in the output produced by the machine learning model 802 is initiated. In other cases, the user device 804 may be a different device, for example, a device of an information technology or like administrator. In this way, the federated AI system can leverage reinforcement learning and HITL learning to generate label data 806. The label data 806 may accordingly be stored and ultimately used for tuning the machine learning model 802.

In some cases, the tuning may be performed against the threshold against which the score for the output is determined, so as to change the value of that threshold. For example, tuning the threshold may cause it to increase or decrease, thereby adjusting the gating measurement for determining when output is of sufficiently high quality for transmittal in response to a user request. In some cases, the output of the machine learning model 802 may be filtered to produce negative label data for tuning the machine learning model 802. For example, the negative label data may be used to tune the machine learning model 802 to differentiate between outputs of varying quality. In some cases, the label data or negative label data produced based on the output of the machine learning model 802 may be used to tune a different machine learning model of the same model chain or of a different model chain.

In some implementations, tuning the machine learning model 802 can include using one or more data sets corresponding to a user or organization (e.g., a software platform customer with which multiple users are associated) to fine-tune performance of the machine learning model 802 to that specific user or entity. For example, the machine learning model 802, and optionally one or more other machine learning models to be used within a model chain, may be tuned (e.g., trained) using data specific to a field, industry, or other aspect related to the user or organization, or otherwise using user- or organization-specific data, obtained with complete affirmative consent from the subject user or organization. The tuning may occur before the machine learning model(s) are used to perform inference operations against user requests for the user or organization and/or between performance of inference operations for such user requests.

For example, the machine learning model 802 may be tuned using a first data set including data samples corresponding to a user or organization prior to the machine learning model 802 being used to perform an inference operation against any user request initiated on behalf of that user or organization (e.g., at a user device associated with that user or organization). The machine learning model 802, tuned according to that first data set, may then be used to perform an inference operation based on a user request. Thereafter, the machine learning model 802 may be retuned using a second data set including other data samples corresponding to the user or organization. The retuned machine learning model 802 may then be used to perform another inference operation based on another user request.

In such cases, the machine learning model 802 is customized for use with the subject user or organization and is thus tailored specifically to provide accurate inference operation results according to the data set(s) corresponding to that user or organization. Such a data set may, for example, include pairs of input and output demonstrating satisfactory and/or unsatisfactory processing and correspond to one or more data formats, such as text, imagery, audio, or the like. The data set may include a small or large number of samples that may derive from one or more sources (e.g., aggregated across a pool of user devices associated with an organization). The federated AI system, when using one or more machine learning models tuned according to user- or organization-specific training data, may thus be considered as a customized federated AI system in that it is customized for use by a specific user or organization.

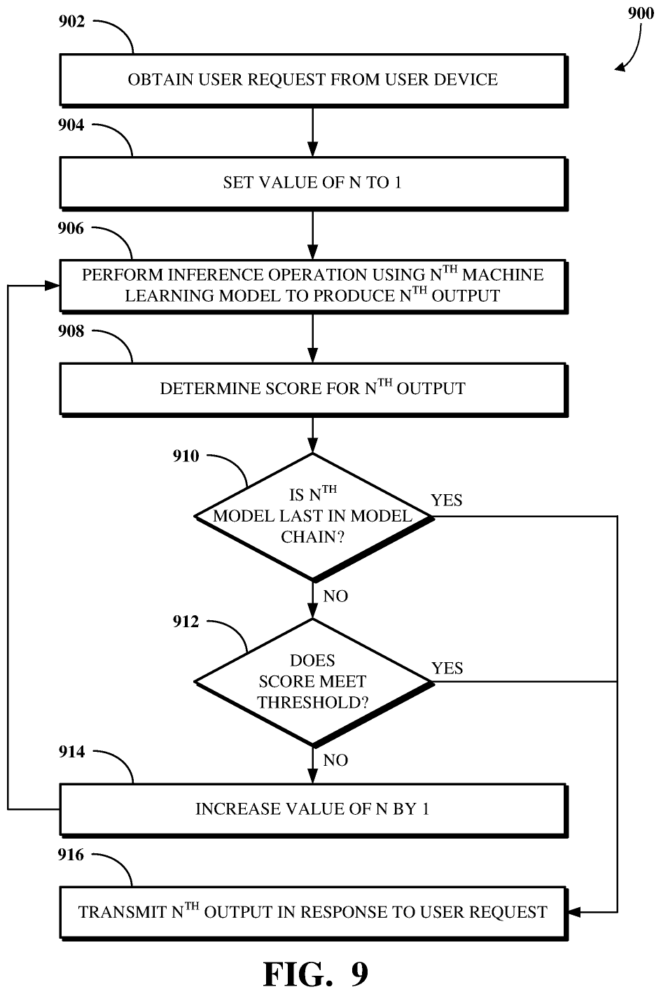

To further describe some implementations in greater detail, reference is next made to examples of techniques which may be performed by or using a federated AI system. FIG. 9 is a flowchart of an example of a technique 900 for determining and serving a response to a user request using a federated AI system. The technique 900 can be executed using computing devices, such as the systems, hardware, and software described with respect to FIGS. 1-8. The technique 900 can be performed, for example, by executing a machine-readable program or other computer-executable instructions, such as routines, instructions, programs, or other code. The steps, or operations, of the technique 900, or another technique, method, process, or algorithm described in connection with the implementations disclosed herein can be implemented directly in hardware, firmware, software executed by hardware, circuitry, or a combination thereof.

For simplicity of explanation, the technique 900 is depicted and described herein as a series of steps or operations. However, the steps or operations of the technique 900 can occur in various orders and/or concurrently. Additionally, other steps or operations not presented and described herein may be used. Furthermore, not all illustrated steps or operations may be required to implement a technique in accordance with the disclosed subject matter.

At 902, a user request is obtained from a user device. The user request is initiated at the user device in connection with one or more features of a software service accessed by or otherwise accessible to the user device. For example, the user request may be a request to identify objects within an image or video, a request for a summary of all instances in which a certain topic was under discussion throughout a series of recurring video conferences, or a request to generate a chat message that can be sent to a group of software users.

At 904, a value of a variable N is set to 1. The variable N may be considered an integer used simply for tracking purposes, for the technique 900 to understand which machine learning model of a model chain is currently under execution and/or was previously executed.

At 906, an inference operation is performed using the Nth machine learning model of a model chain to produce Nth output. Thus, while the value of the variable 1 remains at 1, the first machine learning model of the model chain is executed to perform an inference operation to produce first output. The model chain is selected for use with the user request, whether as a universal model chain or a model chain specific to the user request or other criteria. However, the machine learning models of the model chain are generally all of a same type (e.g., all LLMs). The machine learning models of the model chain are arranged in order of computational complexity in which a lowest computational complexity model of the machine learning models is first in the model chain and a highest computational complexity model of the machine learning models is last in the model chain.

The input provided to the Nth machine learning model, against which the inference operation is performed thereby, includes the user request. In some cases, where the Nth machine learning model is other than the first machine learning model, the input provided to the Nth machine learning model may also include one or more other aspects, for example, information representative of the output produced by one or more previous machine learning models and/or information representative of scoring output (e.g., scores and/or rationales) produced by a scoring machine learning model processing such output. Thus, a deliberation approach, such as those described above with respect to FIG. 7, may be used.

At 908, a score is determined for the Nth output. The score is determined using a scoring machine learning model configured to measure quality of output produced by machine learning models of the model chain. The score may be expressed in one of a variety of formats but in any event represents a measure of the performance of the Nth machine learning model in producing the Nth output based on the input provided thereto.

At 910, a determination is made as to whether the Nth machine learning model is a last machine learning model of the model chain. Where the Nth machine learning model is the last machine learning model of the model chain, the technique 900 proceeds to 916, where the Nth output is transmitted in response to the user request, and at which point the processing of the user request using the model chain ceases.

At 912, based on the Nth machine learning model not being the last machine learning model of the model chain, a determination is made as to whether the score determined for the Nth output meets a threshold. The threshold may be universally defined for the model chain, defined for a subset of the machine learning models of the model chain, or defined specifically for use with the Nth machine learning model. As disclosed herein, the specific parameters for determining whether a score meets such a threshold may vary by implementation. Where the score determined for the Nth output meets the threshold, the technique 900 proceeds to 916, where the Nth output is transmitted in response to the user request, and at which point the processing of the user request using the model chain ceases. Thus, in such a case, the score for the Nth output and thus the Nth output meeting the threshold results in a performance of an inference operation by an N+Mth machine learning model of the model chain being prevented, wherein M is an integer value representing the total number of machine learning models following the Nth machine learning model in the model chain.

At 914, based on the score determined for the Nth output failing to meet the threshold, and thus based on the Nth output failing to meet the threshold, the value of N is increased by 1, and the technique returns to 906, where an inference operation is performed using a next machine learning model of the model chain according to the new value of N. The technique 900 thereafter repeats 908 and 910, and 912, as well, where the Nth machine learning model according to the new value of N is determined to not be the last machine learning model of the model chain.

At 916, based on the score determined for the Nth output meeting the threshold, and thus the Nth output meeting the threshold as determined at 914, or based on the Nth machine learning model being the last machine learning model of the model chain as determined at 912, the Nth output is transmitted in response to the user request. Transmitting the Nth output in response to the user request includes causing the Nth output to be provided to the user device at which the user request was initiated, whether directly or indirectly.

In some implementations, where the Nth machine learning model is the last machine learning model of the model chain, performing the inference operation using the Nth machine learning model at 906 and determining the score for the Nth output at 908 can include performing each of multiple individual inference operations to produce multiple candidate Nth outputs and determining scores for each of those multiple candidate Nth outputs or aggregating, averaging, or otherwise combining those multiple candidate Nth outputs and determining a score for the resulting, combined output. In such a case, the third machine learning model is treated as a super processing unit that executes multiple machine learning models to perform those multiple individual inference operations.

In some implementations, the technique 900 may include performing one or more tuning operations to update one or more machine learning models of the model chain, one or more thresholds used for score comparisons, or other information involved in the processing of the user request using the model chain. Implementations and examples of such tuning operations are described above with respect to FIG. 8.

The implementations of this disclosure describe methods, systems, devices, apparatuses, and non-transitory computer readable media for conference video stream annotation. In some implementations, a method comprises, a non-transitory computer readable medium stores instructions operable to cause one or more processors to perform operations comprising, and/or a system comprises a memory subsystem storing instructions and processing circuitry configured to execute the instructions for: performing, using a first machine learning model of a model chain, a first inference operation to produce first output based on a user request; determining, using a scoring machine learning model configured to measure quality of output produced by machine learning models of the model chain, that the first output fails to meet a threshold; performing, using a second machine learning model of the model chain based on the first output failing to meet the threshold, a second inference operation to produce second output based on the user request, wherein the second machine learning model has a higher computational complexity than the first machine learning model; determining, using the scoring machine learning model, that the second output meets the threshold; and transmitting, based on the second output meeting the threshold, the second output in response to the user request.

In some implementations of the method, the non-transitory computer readable medium, and/or the system, determining that the first output fails to meet the threshold comprises: producing, by the scoring machine learning model, scoring output including a score to compare against the threshold and data representing a rationalization of the score, and wherein performing the second inference operation to produce the second output based on the user request comprises: performing the second inference operation using input including the user request and the scoring output.

In some implementations of the method, the non-transitory computer readable medium, and/or the system, performing the second inference operation to produce the second output based on the user request comprises: performing the second inference operation using input including the user request and the first output.

In some implementations of the method, the non-transitory computer readable medium, and/or the system, the method comprises, the operations comprise, and/or the processing circuitry is configured to execute the instructions for: obtaining, based on the first output failing to meet the threshold, labeling data associated with the user request, wherein performing the second inference operation to produce the second output based on the user request comprises: performing the second inference operation using input including the user request and the labeling data.

In some implementations of the method, the non-transitory computer readable medium, and/or the system, the method comprises, the operations comprise, and/or the processing circuitry is configured to execute the instructions for: selecting the second machine learning model for the model chain based on at least one of the first output or output produced by the scoring machine learning model processing the first output.

In some implementations of the method, the non-transitory computer readable medium, and/or the system, the method comprises, the operations comprise, and/or the processing circuitry is configured to execute the instructions for: determining the model chain based on at least one of the user request or a user device at which the user request is initiated.

In some implementations of the method, the non-transitory computer readable medium, and/or the system, the second output meeting the threshold prevents a performance of a third inference operation using a third machine learning model of the model chain, wherein the third machine learning model has a higher computational complexity than the second machine learning model.

In some implementations of the method, the non-transitory computer readable medium, and/or the system, the first machine learning model and the second machine learning model are a same type of machine learning model trained to produce a same type of output.

In some implementations of the method, the non-transitory computer readable medium, and/or the system, the second machine learning model performs the second inference operation using input including the user request and the first output.

In some implementations of the method, the non-transitory computer readable medium, and/or the system, the machine learning models of the model chain are language learning models.

In some implementations of the method, the non-transitory computer readable medium, and/or the system, the model chain is defined for universal use with user requests.

In some implementations of the method, the non-transitory computer readable medium, and/or the system, the first machine learning model is implemented at a user device and the second machine learning model is implemented at a server device.

In some implementations of the method, the non-transitory computer readable medium, and/or the system, the method comprises, the operations comprise, and/or the processing circuitry is configured to execute the instructions for: determining, using the scoring machine learning model, that the second output fails to meet the threshold; performing, using a last machine learning model of the model chain, multiple third inference operations in parallel based on the user request, wherein each of the third inference operations produces different third output; determining, using the scoring machine learning model, a third output having a highest score amongst the different third output; and transmitting the third output in response to the user request.

In some implementations of the method, the non-transitory computer readable medium, and/or the system, the second machine learning model performs the second inference operation using input including the user request, information representative of the first output, and information representative of scoring output produced by the scoring machine learning model processing the first output.

In some implementations of the method, the non-transitory computer readable medium, and/or the system, the second machine learning model performs the second inference operation using input including the user request, information representative of the first output, and label information associated with the first output.

In some implementations of the method, the non-transitory computer readable medium, and/or the system, the method comprises, the operations comprise, and/or the processing circuitry is configured to execute the instructions for: generating the scoring machine learning model as a discriminative regression model using supervised learning.

In some implementations of the method, the non-transitory computer readable medium, and/or the system, the machine learning models of the model chain are arranged in order of computational complexity in which a lowest computational complexity model of the machine learning models is first in the model chain and a highest computational complexity model of the machine learning models is last in the model chain.

In some implementations of the method, the non-transitory computer readable medium, and/or the system, the user request is initiated in connection with a software service of a unified communications as a service platform.

As used herein, unless explicitly stated otherwise, any term specified in the singular may include its plural version. For example, “a computer that stores data and runs software,” may include a single computer that stores data and runs software or two computers—a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method comprising:
performing, using a first machine learning model of a model chain, a first inference operation to produce first output based on a user request;
determining, using a scoring machine learning model configured to measure quality of output produced by machine learning models of the model chain, that the first output fails to meet a threshold;
performing, using a second machine learning model of the model chain based on the first output failing to meet the threshold, a second inference operation to produce second output based on the user request, wherein the second machine learning model has a higher computational complexity than the first machine learning model;
determining, using the scoring machine learning model, that the second output meets the threshold; and
transmitting, based on the second output meeting the threshold, the second output in response to the user request.

2. The method of claim 1, wherein determining that the first output fails to meet the threshold comprises:
producing, by the scoring machine learning model, scoring output including a score to compare against the threshold and data representing a rationalization of the score, and
wherein performing the second inference operation to produce the second output based on the user request comprises:
performing the second inference operation using input including the user request and the scoring output.

3. The method of claim 1, performing the second inference operation to produce the second output based on the user request comprises:
performing the second inference operation using input including the user request and the first output.

4. The method of claim 1, comprising:
obtaining, based on the first output failing to meet the threshold, labeling data associated with the user request,
wherein performing the second inference operation to produce the second output based on the user request comprises:
performing the second inference operation using input including the user request and the labeling data.

5. The method of claim 1, comprising:
selecting the second machine learning model for the model chain based on at least one of the first output or output produced by the scoring machine learning model processing the first output.

6. The method of claim 1, comprising:
determining the model chain based on at least one of the user request or a user device at which the user request is initiated.

7. The method of claim 1, wherein the second output meeting the threshold prevents a performance of a third inference operation using a third machine learning model of the model chain, wherein the third machine learning model has a higher computational complexity than the second machine learning model.

8. The method of claim 1, wherein the first machine learning model and the second machine learning model are a same type of machine learning model trained to produce a same type of output.

9. A non-transitory computer readable medium storing instructions operable to cause one or more processors to perform operations comprising:
performing, using a first machine learning model of a model chain, a first inference operation to produce first output based on a user request;
determining, using a scoring machine learning model configured to measure quality of output produced by machine learning models of the model chain, that the first output fails to meet a threshold;
performing, using a second machine learning model of the model chain based on the first output failing to meet the threshold, a second inference operation to produce second output based on the user request, wherein the second machine learning model is a higher computational complexity model than the first machine learning model;
determining, using the scoring machine learning model, that the second output meets the threshold; and
transmitting, based on the second output meeting the threshold, the second output in response to the user request.

10. The non-transitory computer readable medium of claim 9, wherein the second machine learning model performs the second inference operation using input including the user request and the first output.

11. The non-transitory computer readable medium of claim 9, wherein the machine learning models of the model chain are language learning models.

12. The non-transitory computer readable medium of claim 9, wherein the model chain is defined for universal use with user requests.

13. The non-transitory computer readable medium of claim 9, wherein the first machine learning model is implemented at a user device and the second machine learning model is implemented at a server device.

14. A system, comprising:
a memory subsystem storing instructions; and
processing circuitry configured to execute the instructions to
perform, using a first machine learning model of a model chain, a first inference operation to produce first output based on a user request;
determine, using a scoring machine learning model configured to measure quality of output produced by machine learning models of the model chain, that the first output fails to meet a threshold;
perform, using a second machine learning model of the model chain based on the first output failing to meet the threshold, a second inference operation to produce second output based on the user request, wherein the second machine learning model has a higher computational complexity than the first machine learning model;
determine, using the scoring machine learning model, that the second output meets the threshold; and
transmit, based on the second output meeting the threshold, the second output in response to the user request.

15. The system of claim 14, wherein the processing circuitry is configured to execute the instructions to:
determine, using the scoring machine learning model, that the second output fails to meet the threshold;
perform, using a last machine learning model of the model chain, multiple third inference operations in parallel based on the user request, wherein each of the third inference operations produces different third output;
determine, using the scoring machine learning model, a third output having a highest score amongst the different third output; and
transmit the third output in response to the user request.

16. The system of claim 14, wherein the second machine learning model performs the second inference operation using input including the user request, information representative of the first output, and information representative of scoring output produced by the scoring machine learning model processing the first output.

17. The system of claim 14, wherein the second machine learning model performs the second inference operation using input including the user request, information representative of the first output, and label information associated with the first output.

18. The system of claim 14, wherein the processing circuitry is configured to:
generate the scoring machine learning model as a discriminative regression model using supervised learning.

19. The system of claim 14, wherein the machine learning models of the model chain are arranged in order of computational complexity in which a lowest computational complexity model of the machine learning models is first in the model chain and a highest computational complexity model of the machine learning models is last in the model chain.

20. The system of claim 14, wherein the user request is initiated in connection with a software service of a unified communications as a service platform.
